(19) United States
(12) Patent Application Publication
(10) Pub. No.: US 2009/0086504 A1
(43) Pub. Date: Apr. 2, 2009

(54) Backlit erasable writing board

(75) Inventor: Steven Kim, Palisades Park, NJ (US)

Correspondence Address: SEYFARTH SHAW, LLP, 815 CONNECTICUT AVENUE, N.W., SUITE 500, WASHINGTON, DC, 20006, US

(73) Assignee: LED Folio Corporation, Palisades Park, NJ (US)

(21) Appl. No.: 11/905,604

(22) Filed: Oct. 2, 2007

(51) Int. Cl. F21V 8/00

(52) U.S. Cl. 362/612

(57) ABSTRACT

A backlit erasable writing board includes a light guide panel, a plurality of light emitting diodes positioned on at least one side surface of the light guide panel for providing light to the light guide panel, a reflecting plate at a back surface of the light guide panel for reflecting light toward a front surface of the light guide panel, and an impervious translucent film at the front surface of the light guide panel for use as an erasable writing surface.

### BACKGROUND OF THE INVENTION

1. Field of The Invention

Embodiments of the present invention relates to an erasable writing board, and more particularly, to a backlit erasable writing board. Although embodiments of the present invention are suitable for a wide scope of applications, they are particularly suitable for use in low-light environment.

2. Discussion Of The Related Art

In general, a whiteboard is an impervious writing surface that has a white color. Typically, an erasable ink is used for writing upon the whiteboard. The erasable ink can be readily removed with a whiteboard eraser, cloth, paper, or the like even when the erasable ink has been on the impervious surface for a long period of time. Thus, a whiteboard is like a chalkboard that uses ink for writing or drawing instead of chalk.

FIG. 1A is a perspective view of a whiteboard according to the related art. As shown in FIG. 1A, the whiteboard 100 has a writing surface 101 encircled by a frame 102. The writing surface 101 is a white-colored resin or white-colored enamel. Such a resin or enamel is opaque. The frame 102 can be a metal, wood, synthetic or composite material.

FIG. 1B is a cross-sectional view of a whiteboard along line I-I′ of FIG. 1A. As shown in FIG. 1B, the writing surface 101 is on a substrate 103. Typically, the impervious material of writing surface is not thick enough to be sufficiently rigid for writing purposes and/or for overall support purposes for the whole whiteboard. Either the impervious material is inherently thin, such as an enamel, or the thickness of the impervious material is reduced so as to reduce cost. Thus, the writing surface 101 is mounted on a substrate 103 to provide rigidity to the writing surface 101 as well as to provide overall support to the for the whole whiteboard. The substrate 103 can be a composite material, such as fiberboard or masonite. The writing surface 101 can be directly attached to the substrate 103 with an adhesive or attached to the substrate 101 by the frame 102 encompassing both the substrate 103 and the writing surface.

A whiteboard is used for temporarily displaying concepts and/or ideas to a group of people. More specifically, a whiteboard can be used as visual aid to facilitate a meeting or to garner results from a meeting. For example, the whiteboard can be used to present topics that need be addressed. In another example, the whiteboard can be used to capture concepts resulting from discussions during a meeting. Thus, a whiteboard can be a focal point of a meeting.

Projectors and flat panel displays are also used in meetings for presentation purposes. Examples of projectors include LCD projectors and overhead projectors. Typically, room lighting is dimmed or turned off so that presentations using a projector can be more readily viewed by the participants of the meeting. Further, room lighting may also be dimmed or turned off for presentations using flat panel displays.

When a whiteboard is to be used in conjunction with a projector or flat panel display, the room lights have to bright enough to read the whiteboard or turned on while the whiteboard is being used. If the room lights are bright enough to read the whiteboard, the room lights may be too bright for meeting participants to be able to easily see the presentation from the projector or flat panel display. Further, constantly turning off and on the room lights so that the whiteboard can be used intermittently during a presentation is uncomfortable for the meeting participants because their eyes are having to constantly readjust.

### SUMMARY OF THE INVENTION

Accordingly, embodiments of the present invention are directed to backlit erasable writing board that substantially obviate one or more of the problems due to limitations and disadvantages of the related art.

An object of the present invention is to provide a backlit erasable writing board that can be seen in low-light conditions.

Another object of the present invention is to prevent heating of backlit erasable writing board in which the writing surface is not heated by the lighting source.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a backlit erasable writing board includes a light guide panel, a plurality of light emitting diodes positioned on at least one side surface of the light guide panel for providing light to the light guide panel, a reflecting plate at a back surface of the light guide panel for reflecting light toward a front surface of the light guide panel, and an impervious translucent film at the front surface of the light guide panel for use as an erasable writing surface.

In another aspect, a backlit erasable writing board includes a light guide panel, a plurality of light emitting diodes positioned on at least one side surface of the light guide panel for providing light to the light guide panel, a frame at a side surface of the light guide panel having a reflective internal surface for reflecting light for the plurality of light emitting diodes toward the side surface of the light guide panel, a reflecting plate at a back surface of the light guide panel for reflecting light toward a front surface of the light guide panel, and an impervious translucent film at the front surface of the light guide panel for use as an erasable writing surface.

In yet another aspect, a backlit erasable writing board includes a light guide panel, a plurality of light emitting diodes on metallic strips positioned on at least one side surface of the light guide panel for providing light to the light guide panel, a frame at a side surface of the light guide for thermally conducting heat away from the plurality of light emitting diodes through the metallic strips, a reflecting plate at a back surface of the light guide panel for reflecting light toward a front surface of the light guide panel, and an impervious translucent film at the front surface of the light guide panel for use as an erasable writing surface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A is a perspective view of a whiteboard according to the related art;

FIG. 1B is a cross-sectional view of a whiteboard along line I-I′ of FIG. 1B;

FIG. 2A is a front view of a backlit erasable writing board according to a first embodiment of the present invention;

FIG. 2B is a cross-sectional view of a backlit erasable writing board along the line II-II′ of FIG. 2A;

FIG. 2C is a back perspective view of a backlit erasable writing board according to a first embodiment of the present invention; and

FIG. 3 is a cross-sectional view of a backlit erasable writing board according to a second embodiment of the present invention.

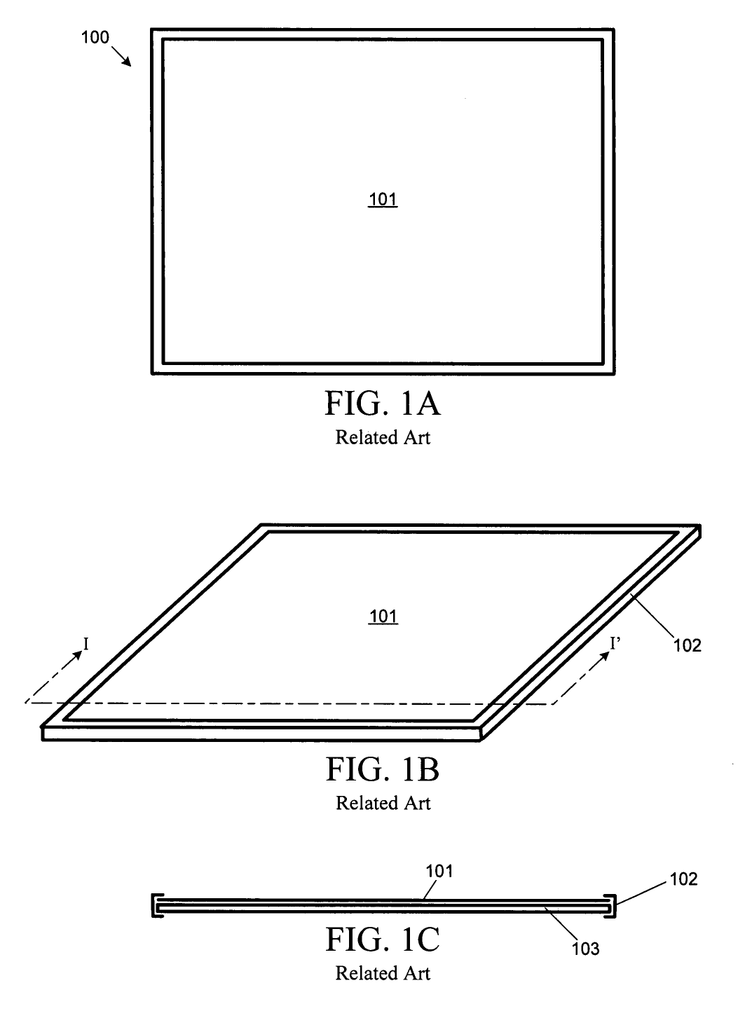

### DETAILED DESCRIPTION OF THE PREFERRED EMBODIMENTS

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

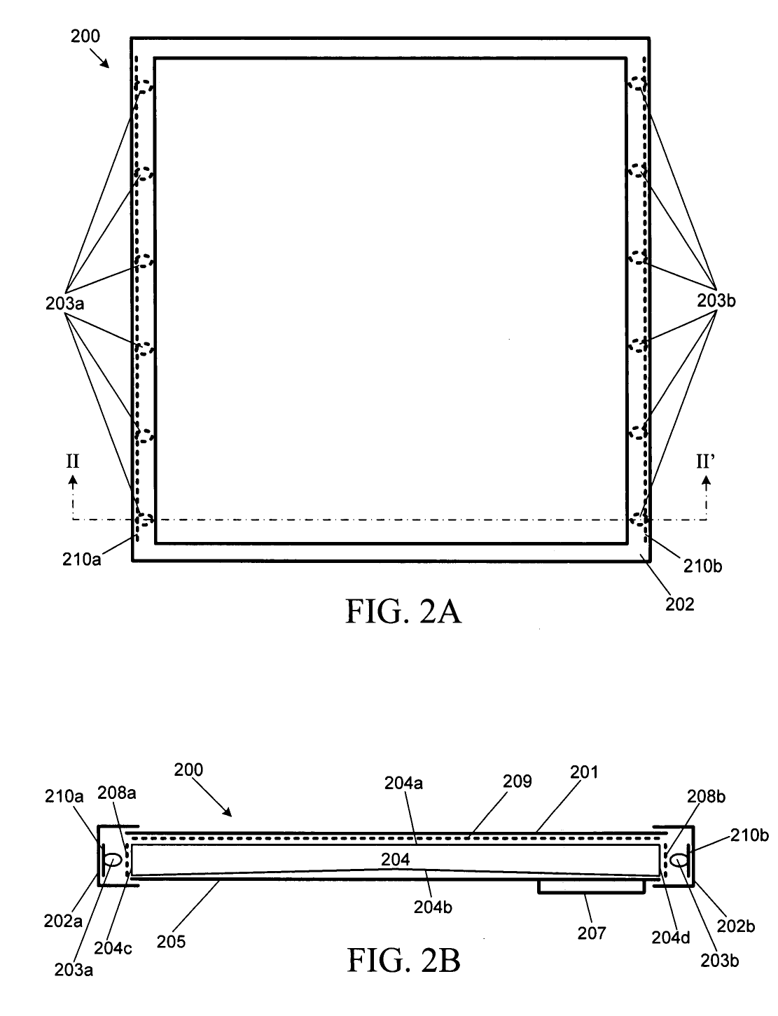

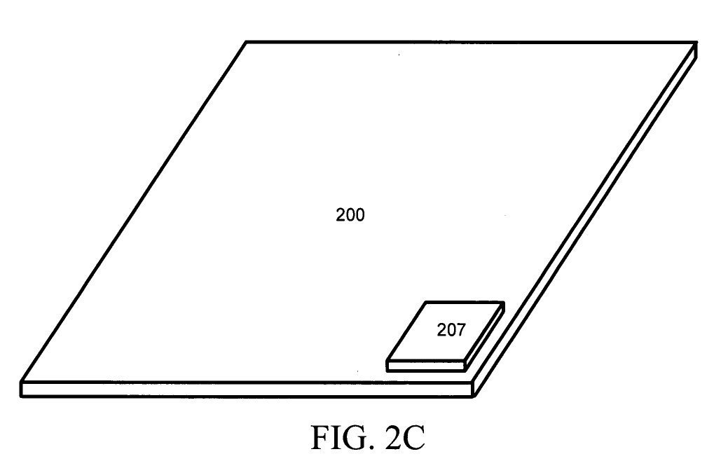

FIG. 2A is a front view of a backlit erasable writing board according to a first embodiment of the present invention. As shown in FIG. 2A, a backlit erasable writing board 200 includes an erasable writing surface 201, which is translucent and impervious to erasable ink, and a frame 202 surrounding the erasable writing surface 201. A first set of light emitting diodes 203a is positioned on one side of the erasable writing surface 201 within the frame 202 and a second set of light diodes 203b is positioned at a second side of the erasable writing surface 201. More specifically, the first and second sets of light emitting diodes 203a and 203b are on opposite sides of the erasable writing surface 201. Although the first and second sets of light emitting diodes 203a and 203b are shown directly opposing each other in FIG. 2A, the first and second sets of light emitting diodes 203a and 203b can be on opposite sides of the erasable writing surface 201 but yet offset from one another. Further, an additional set or sets of light emitting diodes can be provided at another side or other sides of the erasable writing surface to increase light output from the erasable writing surface 201.

FIG. 2B is a cross-sectional view of a backlit erasable writing board along line II-II′ of FIG. 2A. As shown in FIG. 2B, a backlit erasable writing board 200 includes a light guide panel 204 for receiving light from the light emitting diodes 203a and 203b and then distributes the light across the light guide panel 204 so that light is evenly emitted from the front surface 204a of the light guide panel 204. A reflector plate 205 at the back surface 204b of the light guide panel 204 reflects light toward the front surface 204a of the light guide panel 204. A power supply 207 can also be mounted on the reflector plate 205 at the back of the backlit erasable writing board 200.

The light emitting diodes 203a and 203b can be white light emitting diodes. In the alternative, the light emitting diodes 203a and 203b can include red, blue and green light emitting diodes that are positioned along the sides of the light guide panel 204 such that the red, blue and green lights from the red, blue and green light emitting diodes combine into white light. In another alternative, the light emitting diodes 203a and 203b can be blue light emitting diodes. In yet another alternative, the light emitting diodes 203a and 203b can be ultraviolet light emitting diodes. In the cases of blue light emitting diodes and ultraviolet light emitting diodes, a color conversion structure is needed to convert the blue light or the ultraviolet light into white light.

As shown in FIG. 2B, the color conversion structure can either be a pair of color conversion films 208a and 208b at the at least two side surfaces 204c and 204d of the light guide panel 204 or a single color conversion film 209 at the front surface 204a of the light guide panel 204. For example, the pair of color conversion films 208a and 208b can be positioned directly on the at least two side surfaces 204c and 204d of the light guide panel 204 that face the light emitting diodes 203a and 203b. In another example, the single color conversion film 209 can be positioned at the front surface 204a of the light guide panel 204. These color conversion structures can either convert ultraviolet light to white light or blue light to white light.

An impervious translucent film is positioned at the front surface 204a of the light guide panel 204 for use as an erasable writing surface 201. More specifically, a white or off-white translucent resin can be used as the erasable writing surface 201. The white color can be achieved through pigmentation in the resin. Further, the translucent resin of the erasable writing surface 201 can contain additives for diffusing light from the light guide panel 204. In addition or in the alternative to the additives, the translucent resin can have geometric patterns (not shown) on the side of the translucent film facing the light guide panel for diffusing light from the light guide panel 204.

The frame 202 surrounds the light guide panel 204. The frame 202 can be made of metal. Internal surfaces 202a and 202b of such a metallic frame 202 can be polished or smoothed to reflect light from the light emitting diodes 203a and 203b toward at least two side surfaces 204c and 204d of the light guide panel 204. Further, the metallic frame 202 thermally conducts heat from the light emitting diodes 203a and 203b. Thus, the metallic frame 202 can act as a heatsink for the light emitting diodes 203a and 203b so as to prevent the erasable writing surface 201 from being heated by the light emitting diodes 203a and 203b. For example, the light emitting diodes 203a on one side of the backlit erasable writing board 200 can each be mounted on a metallic strip 210a for removing heat from the light emitting diodes 203a and the metallic strip 210a is contacted against internal surface 202a of the metallic frame 202. The light emitting diodes 203b on the other side of the backlit erasable writing board 200 have a metallic strip 210b contacted against the internal surface 202b of the metallic frame 202. By preventing heat from reaching the erasable writing surface 201, erasable ink can be consistently scribed across the entire surface of the erasable writing surface 201.

FIG. 2C is a back perspective view of a backlit erasable writing board according to a first embodiment of the present invention. As shown in FIG. 2C, a power supply 207 is mounted at the back surface of the backlit erasable writing board 200. For example, the power supply 207 convert 120 VAC to 12 VDC to drive the light emitting diodes 203 to emit light at a predetermined brightness. In the alternative, the power supply 207 can be a variable power supply that can selectively output a voltage within a range of voltages to the light emitting diodes 203a and 203b such that the light output of backlit erasable writing board 200 can be controlled to output one of a variety of different brightness levels. Such a variable power supply enables the brightness of the backlit erasable writing board to be adjusted to the appropriate contrast with respect to external lighting conditions.

Embodiments of the invention can provide evenly distributed visible light through the erasable writing surface 201 to create high contrast with respect erasable inks that are scribed upon the erasable writing surface 201. Accordingly, writings or drawings on the erasable writing surface 201 backlit by the light emitting diodes 203 through the light guide panel 204 can be readily seen in dark or low ambient lighting conditions. In the alternative, fluorescent pigments can be added to the erasable ink such that writings or drawings on the backlit erasable writing surface fluoresce and still have sufficient contrast with the backlit erasable writing surface to be seen in dark or low ambient lighting.

In the case of using fluorescing erasable ink, the light transmitted through the erasable writing surface 201 can be a combination of visible light and ultraviolet light, or just ultraviolet light. For example, a backlit erasable writing board according to embodiments of the present invention can have a combination of visible light emitting diodes and ultraviolet light emitting diodes used together to provide both visible light and ultraviolet light through the erasable writing surface 201. In another example, a backlit erasable writing board according to embodiments of the present invention can only have ultraviolet light emitting diodes to provide only ultraviolet light through the erasable writing surface 201. In yet another example, a backlit erasable writing board 200 according to embodiments of the present invention can have both visible light emitting diodes and ultraviolet light emitting diodes that are separately controllable such that the backlit erasable writing board has three lighting modes of ultraviolet, visible and ultraviolet/visible transmitted through the erasable writing surface 201.

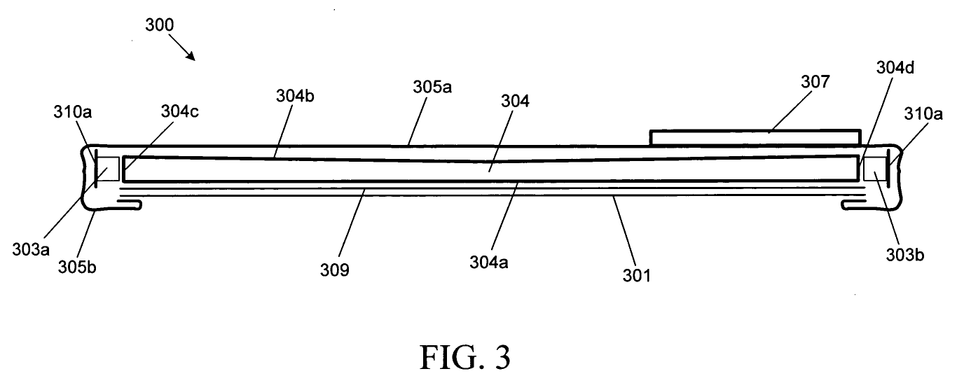

FIG. 3 is a cross-sectional view of a backlit erasable writing board according to a second embodiment of the present invention. As shown in FIG. 3, a backlit erasable writing board 300 includes first and second sets of light emitting diodes 303a and 303b at opposite sides of the erasable writing surface 301. A light guide panel 304 receives light from the first and second sets of light emitting diodes 303a and 303b and then distributes the light throughout the light guide panel 304 so that light is evenly emitted from the front surface 304a of the light guide panel.

A back reflector part 305a is positioned on a back surface 304b of the light guide panel 304 and also partially surrounds the light emitting diodes 303a and 303b so as to reflect light toward a front surface 304a of the light guide panel 304 and reflect light from the light emitting diodes 303a and 303b toward the light guide panel 304. The back reflector 305a can be made of a heat conductive material such that metallic strips 310a and 310b, on which the light emitting diodes 303a and 303b are mounted, can be positioned to contact the back reflector 305a to conduct heat away from the light emitting diodes.

A power supply 307 is mounted on the back reflector part 305a at the back surface of the backlit erasable writing board 300. A diffusion film 309 is positioned at the front surface 304a of the light guide panel 304. An impervious translucent film is positioned on the diffusion film 309 to serve as an erasable writing surface 301.

A shown in FIG. 3, a front reflector part 305b is positioned over the front surface 304a of the light guide panel 304. Further, the front reflector 305b also partially surrounds the light emitting diodes 303a and 303b so as to reflect light toward a front surface 304a of the light guide panel 304. The front reflector 305b together with the back reflector 305a encases the first and second sets of light emitting diodes 303a and 303b, the light guide panel 304, the diffusion film 309 and the erasable writing surface 301. The front reflector 305b can be made of a heat conductive material such that metallic strips 310a and 310b, on which the light emitting diodes 303a and 303b are mounted, can be positioned to contact the front reflector 305b to conduct heat away from the light emitting diodes 303a and 303b.

The front reflector 305b can be integral with the back reflector 305a in that part of the back reflector part 305a is bent over the light emitting diodes 303a and 303b, the light guide panel 304, the diffusion film 309 and the erasable writing surface 301 during manufacturing. For example, a single metallic sheet can be rolled around the edges of the light guide panel 304 to serve as a reflector at the back surface of the light guide panel 304 and as a frame at the side surfaces of the light guide panel 304. In the case of the back reflector 305a and the front reflector 305b being an integrated as a single metallic sheet, heat from the light emitting diodes 303a 303b is dissipated through both the front reflector 305b and the back reflector 305a. In the alternative, the front reflector part 305b can be attached to the back reflector part 305a with one of adhesive, rivets, screws and soldering.

It will be apparent to those skilled in the art that various modifications and variations can be made to low-clearance lighting of the present invention without departing from the spirit or scope of the invention. Thus, it is intended that the present invention cover the modifications and variations of this invention provided they come within the scope of the appended claims and their equivalents.

What is claimed is:

1. A backlit erasable writing board, comprising:
a light guide panel;
a plurality of light emitting diodes positioned on at least one side surface of the light guide panel for providing light to the light guide panel;
a reflecting plate at a back surface of the light guide panel for reflecting light toward a front surface of the light guide panel; and
an impervious translucent film at the front surface of the light guide panel for use as an erasable writing surface.

2. The backlit erasable writing board of claim 1, wherein the impervious translucent film is one of white and off-white in color.

3. The backlit erasable writing board of claim 1, wherein the impervious translucent film is a resin containing an additive for diffusing light from the light guide panel.

4. The backlit erasable writing board of claim 1, further comprising a variable power supply that can selectively output a voltage within a range of voltages to the plurality of light emitting diodes such that light output of the backlit erasable writing board can be controlled to output one of different brightness levels.

5. The backlit erasable writing board of claim 1, wherein the plurality of light emitting diodes include visible light emitting diodes and ultraviolet light emitting diodes.

6. The backlit erasable writing board of claim 5, wherein the visible light emitting diodes and ultraviolet light emitting diodes that are separately controllable such that three lighting modes of ultraviolet, visible and ultraviolet/visible can be transmitted through the erasable writing surface.

7. The backlit erasable writing board of claim 1, wherein the plurality of light emitting diodes includes one of a blue light emitting diode and an ultraviolet light emitting diode.

8. The backlit erasable writing board of claim 7, further comprising a color conversion film at the front side of the light guide panel.

9. The backlit erasable writing board of claim 7, further comprising a color conversion films on the at least one side surface of the light guide panel adjacent to the plurality of light emitting diodes.

10. A backlit erasable writing board, comprising:
a light guide panel;
a plurality of light emitting diodes positioned on at least one side surface of the light guide panel for providing light to the light guide panel;
a frame at a side surface of the light guide panel having a reflective internal surface for reflecting light for the plurality of light emitting diodes toward the side surface of the light guide panel;
a reflecting plate at a back surface of the light guide panel for reflecting light toward a front surface of the light guide panel; and
an impervious translucent film at the front surface of the light guide panel for use as an erasable writing surface.

11. The backlit erasable writing board of claim 10, wherein the impervious translucent film is one of white and off-white in color.

12. The backlit erasable writing board of claim 10, wherein the impervious translucent film is a resin containing an additive for diffusing light from the light guide panel.

13. The backlit erasable writing board of claim 10, further comprising a variable power supply that can selectively output a voltage within a range of voltages to the plurality of light emitting diodes such that light output of the backlit erasable writing board can be controlled to output one of different brightness levels.

14. The backlit erasable writing board of claim 10, wherein the plurality of light emitting diodes include visible light emitting diodes and ultraviolet light emitting diodes.

15. The backlit erasable writing board of claim 14, wherein the visible light emitting diodes and ultraviolet light emitting diodes that are separately controllable such that three lighting modes of ultraviolet, visible and ultraviolet/visible can transmitted through the erasable writing surface.

16. The backlit erasable writing board of claim 10, wherein the plurality of light emitting diodes includes one of a blue light emitting diode and an ultraviolet light emitting diode.

17. The backlit erasable writing board of claim 16, further comprising a color conversion film at the front side of the light guide panel.

18. The backlit erasable writing board of claim 16, further comprising a color conversion films on the at least one side surface of the light guide panel adjacent to the plurality of light emitting diodes.

19. The backlit erasable writing board of claim 10, wherein the frame and the reflecting plate are parts of a metallic sheet.

20. A backlit erasable writing board, comprising:
a light guide panel;
a plurality of light emitting diodes on metallic strips positioned on at least one side surface of the light guide panel for providing light to the light guide panel;
a frame at a side surface of the light guide for thermally conducting heat away from the plurality of light emitting diodes through the metallic strips;
a reflecting plate at a back surface of the light guide panel for reflecting light toward a front surface of the light guide panel; and
an impervious translucent film at the front surface of the light guide panel for use as an erasable writing surface.
